(19) United States
(12) Patent Application Publication
(10) Pub. No.: US 2013/0336238 A1
(43) Pub. Date: Dec. 19, 2013

(54) HOSPITALITY-BASED TELECOMMUNICATION SYSTEM AND METHOD

(71) Applicants: JEFFREY A. CONVERSE, SAN CLEMENTE, CA (US); DARREN POUND, LAGUNA NIGUEL, CA (US)

(72) Inventors: JEFFREY A. CONVERSE, SAN CLEMENTE, CA (US); DARREN POUND, LAGUNA NIGUEL, CA (US)

(21) Appl. No.: 13/803,713

(22) Filed: Mar. 14, 2013

Related U.S. Application Data
(60) Provisional application No. 61/661,671, filed on Jun. 19, 2012.

(51) Int. Cl. H04W 76/02

(52) U.S. Cl. CPC H04W 76/02
USPC 370/329

(57) ABSTRACT

An interactive hospitality facility communication system. The system includes a user application, a web server, and a communication module. The application is downloadable to a user's personal electronic device. The web server stores information and content relating to the local hospitality facility. The communication module connects the user's personal electronic device to a PBX system located at the facility. The user is thus able to communicate with both the web server and the PBX system with their device via the user application.

A method of enabling interactive communication between a hospitality facility and a user. The method includes connecting a user's personal electronic device to the facility's infrastructure and transmitting data between the application and the infrastructure. The facility's infrastructure may include a web server that contains information relating to the hospitality facility and its amenities and a communication module that connects the user application to the facility's PBX system.

### CROSS-REFERENCE TO RELATED APPLICATIONS

The present non-provisional patent application claims priority to United States Provisional Patent Application Ser. No. 61/661,671, entitled HOSPITALITY-BASED TELECOMMUNICATION SYSTEM AND METHOD filed Jun. 19, 2012, all of the teachings of which are incorporated herein by reference.

### STATEMENT RE: FEDERALLY SPONSORED RESEARCH/DEVELOPMENT

Not Applicable

### BACKGROUND

1. Field of the Invention

Embodiments of the present invention relate to systems and methods for communicating and interacting with and among customers in the hospitality industry. More particularly, embodiments of the present invention relate to systems and methods for interactively communicating between the hospitality facility and a customer utilizing the customer's personal electronic device (e.g., a mobile communication device, such as a smartphone) and the facility's Private Branch Exchange (PBX) telephony system.

2. Description of the Related Art

Communication with customers in the hospitality industry may take a number of different forms. Including, for example, communication between the hospitality facility and the customer, between the customer and endpoints outside of the hospitality facility, and between customers within the hospitality facility. Traditionally, this communication has occurred via a telephone in the customer's room, or dedicated hospitality phones located within the facility. More advanced technologies have allowed for additional methods of communication. For example, information about the hospitality facility may be broadcast to the customer via a channel on the television in the customer's room, customers may check out of their room using an interactive feature on the television or an in-room computer, and facilities have made available access to the internet in the customer's room and within the facility in general via either wired Ethernet connections and/or wireless WiFi connections. This internet connection is usually accessed by a computer provided by the hospitality facility or via a laptop computer brought by the guest. However, it can be expensive for the facility to provide a dedicated computer for each guest and not all guests bring their own laptops. In recent years, the growth of ownership of personal electronic devices, such as smartphones and tablet computers has been enormous and has reached a point where most customers have such a mobile computing device with them at all times. It would be beneficial to allow hospitality facility customers to communicate within the facility utilizing these mobile computing devices they already own.

Previously there have been “stand alone” apps in the market for specific hotels. These previously existing apps, however, are just that, “stand alone” apps. You are able access room service and valet with web access anywhere in the world, but this presents a problem if you are not currently staying at that hotel property. If used from across the world, the hotel will field needless calls from the application thereby affecting existing guests' quick and proper service. These stand alone apps may share resort property information with you, but this information is generally already available from their web page. The previous “stand alone” apps also do not support existing PBX systems already installed in the hospitality facility. They are apps that are built and rarely updated for content because it's web based and designer controlled as to content.

Examples of prior attempts at integrating the hospitality facility experience using guests existing smart phones while on properties include applications that allow on-property guests to use their own smartphone or tablet devices to place calls and send messages over the hotel's Wi-Fi network without incurring international cell phone roaming charges. Guests can create user profiles to contact staff directly, tailor personal deal preferences, book spa appointments, reserve excursions and more. The applications also provide information about dining, amenities, resort activities, local attractions and the like. Previous applications have utilized wifi and VoIP protocols to allow for communication over the facility's wireless connection, thereby bypassing a hospitality facilities currently existing PBX system. This, however, eliminates the beneficial PBX interaction/redirection of hotel to guest communication. Also by integrating with any wifi connection, this application can work anywhere in the world, which as previously discussed, can be problematic. Further, these apps have been specific to only that one property for which you have downloaded the app, generally only prove one way access from guest to hotel, have limited activity integration, and provide no marketing to inform guests of specific activities, menus, special events, and other specific amenities. Additionally, there has been some attempt at providing information and amenity interactivity via an application on a customer's smartphone or tablet, but again, this generally has only operated via the facility's wifi network with no integration into the PBX system and are custom built for each facility.

As such, there exists a need for a system that works via web access with the hospitality facility's Wifi system, while integrating phone service through the facility's PBX system. Furthermore, there is a need for the information available to the customer to be updated on a regular basis by the facility, so that current, relevant information is always available to the customer. By using the PBX system for phone usage by the hotel and the guest, the life of the PBX system and the existing infrastructure currently in place is extended. There is a need to prolong the life of currently installed PBX systems by incorporating an updated customer communication system that incorporates what is already there at the facility (PBX and Wifi) and combining that with individual guest smartphones. Furthermore, there is a need for the ability to market specifically to traveler demographics. By combining the customer's smartphone, via an application, and integrating it via the facility's wifi to the facility's preexisting PBX system, you are able to avoid the problems of previous systems, namely: only allowing communication while on the facility property and logged into the facility's wifi system, readily updated information about the facility's amenities, and utilization of preexisting PBX systems so that calls are properly routed within the facility.

### BRIEF SUMMARY

One embodiment of the present invention is an interactive hospitality facility communication system. The system includes a user application, a web server, and a communication module. The user application is downloadable to a user's personal electronic device. The web server stores information and content relating to the local hospitality facility. The communication module connects the user's personal electronic device to a PBX system located at the hospitality facility. The user is thus able to communicate with both the web server and the PBX system with their personal electronic device via the user application. The personal electronic device may be a smartphone or a tablet computer.

Another embodiment of the present invention is a method of enabling interactive communication between a hospitality facility and a user. The method includes connecting a user's personal electronic device to the hospitality facility's infrastructure and transmitting data between the user application and the infrastructure. The facility's infrastructure may include a web server that contains information relating to the hospitality facility and its amenities and a communication module that connects the user application to the facility's PBX system.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a hospitality-based telecommunication system according to one embodiment of the present invention; and

FIG. 2 is an operational flowchart of the hospitality-based telecommunication system of FIG. 1.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and or in a different order and that they are also intended to be encompassed within the scope of the invention.

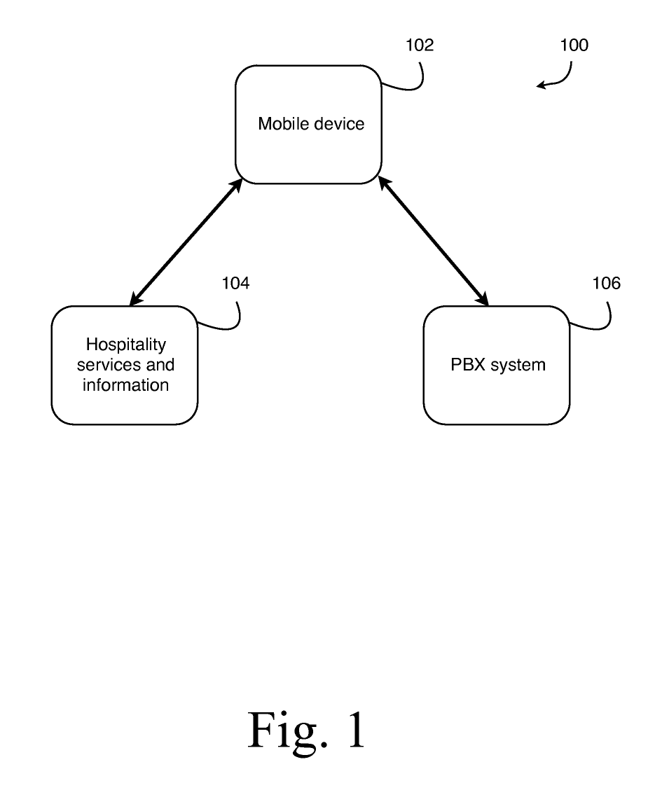

FIG. 1 is a block diagram showing an exemplary hospitality-based telecommunication system 100 in accordance with the present invention. The system 100 is intended to be utilized by a hospitality facility and includes a user application 102 in communication with both a web server 104 and a communication module 106. The user application 102 is downloadable to a user's mobile personal electronic device, such as a smartphone or a tablet computer. The web server 104 stores information and content relating to the local hospitality facility and its amenities. The communication module 106 connects the user's personal electronic device via the user application 102 to a PBX system located at the hospitality facility. The user is thus able to communicate with both the web server 104 and the PBX system with their personal electronic device via the user application 102.

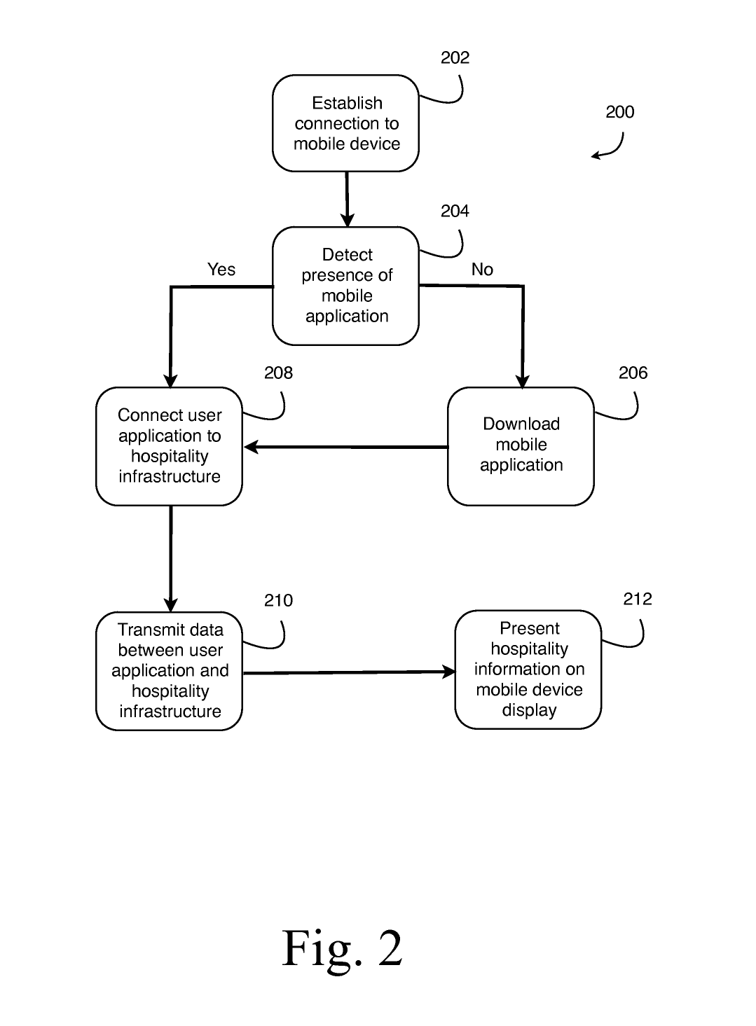

FIG. 2 is an operational flowchart showing a method 200 of enabling interactive communication between a hospitality facility and a user. The method includes a first step 202 of establishing a connection between a mobile device of the user and the hospitality facility. Step 202 may occur by the user manually establishing a connection between the mobile device and a wireless network of the facility, or may be conducted in a more automated manner by the user scanning a Quick Response (QR) code with the mobile device. Step 204 then seeks to determine whether the user application 102 is already installed on the mobile device. If the user application 102 has not already been installed, the user will be prompted in step 206 to download the user application 102 to the mobile device. In step 208, the user application 102 will connect the user's personal electronic device to the hospitality facility's infrastructure. The facility's infrastructure may include a web server 104 that contains information relating to the hospitality facility and its amenities and a communication module 106 that connects the user application to a PBX system located at the facility. At this point, it is possible to transmit data between the user application and the hospitality infrastructure in step 210. The results of such data transfer may be shown on a display of the mobile device for the user to interact with in step 212.

One exemplary embodiment of the systems and methods of the present invention is discussed below. In particular, a single universal user application 102 may be usable at multiple hospitality facilities, rather than having to download an application for each facility or each chain of facilities. In one example, the user is able to scan a QC code at the front desk of a hotel with the user application 102. The user application 102 would then proceed to connect to the web server 104 and the communication module 106 thereby providing access to all PBX hotel extension phones, Wifi based services and information. It should be noted that the systems and methods disclosed herein are intended to be utilized not only at hotels, but at all hospitality facilities, including but not limited to resorts, casinos, vacation clubs, cruise ships, theme parks, commercial office buildings, shopping malls, airports, airline travel, special events, and the like—virtually any operation that has a moderate to large PBX infrastructure.

The smartphone application 102 is intended to work on all mainstream mobile personal electronic devices, including but not limited to mobile phones, tablet computers, PDAs, and the like. The single universal application 102 may be branded by location or chain, so that the display and appearance will be unique for the location you connect to. A home screen of the application 102 will enable the user to access Guest Services, Restaurants, Front Desk, Wake Up Calls, Concierge, Local Attractions, and the like. A user may previously download the application before arriving at the facility, or a QR code may be displayed at the facility allowing for easy downloadability at the facility itself. Each facility will have their own unique QR code that will let the application 102 access their system. The user will download the application 102, sign into the facility's personal Wifi system and authorize how they would like to interact with the facility, for example, through email, text or directly with a phone call. In the case of a hotel, the user would be connected and identified by their room number assignment.

Information relating to the facility will be entered and maintained on a web server 104. A standard template may be provided to hospitality facilities, wherein the information to be entered in the template will be updated and maintained by the individual facility's staff for content including, but not limited to, menus, times of operation, local attractions, daily/weekly special events, etc. The information and user services available on the web server 104 may be directly linked to the user's application 102 via the facility's wireless network.

Hardware and software of the communication module 106 will connect the user's device to the facility's landline-based PBX system. A Session Initiation Protocol (SIP) library for the PBX communication module 106 will allow for self-configuration, thereby turning the user's mobile device into a “softphone”. By creating dynamic custom extensions, this “softphone” connection will allow the user to dial the “extension” at any outlet (room service, valet, concierge, etc.) through the user's own mobile device. Once dialed, the facility's extension will display identifying information about the user, such as name and/or room number. Additionally, the communication module 106 may further interact with a facility's Property Management System (PMS). For example, in the case of a hotel, resort, cruise ship, or the like, wherein guests are checked in using guest room inventory system software, relevant information about the guest may be passed from the PMS to the PBX system via the communication module. An example of this would be that rather than merely showing the guest room number when the user dials a facility extension, the user's name would show, thereby allowing for a more personal experience. Additionally, the PMS information could be relayed to the user application 102 so the user's display likewise carries this personal information. As to the facility calling the guest, it will display on the user's device as the extension from that outlet (e.g., Pool, Lounge, Front Desk, etc.). Furthermore, registered and authorized third party information can be shared and GPS can also be activated to assist in directions and availability of other valid properties. Benefits of integrating the user's mobile device with the preexisting PBX system of the facility include eliminating ownership expense of replacing old or antiquated PBX systems, extending the life of existing landline based PBX systems, total connectivity with on-property guests, ease of install and sign in at guest registration, unlimited on-property marketing opportunities, free cost of use for the guest, interoperability of the application on any hospitality facility using the system, increased security by disconnecting the service upon the user leaving the facility's property, and controlling access to marketing on both sides at check-in for access and info.

The above description is given by way of example, and not limitation. Given the above disclosure, one skilled in the art could devise variations that are within the scope and spirit of the invention disclosed herein, including various ways of connecting the user's personal electronic device to the facility's infrastructure, whether via Bluetooth, ZigBee, or some other wireless protocol. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An interactive communication system for use at a hospitality facility comprising:
a) a web server, wherein information and content relating to the hospitality facility and its amenities is stored therein;
b) a user application in communication with the web server, wherein the user application is downloadable to a user's personal electronic device; and
c) a communication module connecting the user's personal electronic device to a PBX system of the hospitality facility.

2. The system of claim 1, wherein the information contained on the web server includes information regarding, and access to, guest services, restaurants, front desk, wake up calls, concierge, and local attractions.

3. The system of claim 1, wherein the user application is downloaded to a user's smartphone or tablet computer.

4. The system of claim 1, wherein the user application functions at multiple hospitality facilities.

5. The system of claim 1, wherein the user application connects the user's personal electronic device to the web server and communication module by a wireless network.

6. The system of claim 5, wherein the user application disconnects from the web server and communication module upon leaving the wireless network.

7. The system of claim 1, wherein identifying information of the user is provided to the PBX system when the user connects to a facility amenity.

8. The system of claim 7, wherein the identifying information is a room number assigned to the user.

9. The system of claim 1, wherein location information is displayed on the user's personal electronic device when an incoming phone call is placed by the facility.

10. A method of enabling interactive communication between a hospitality facility and a user, said method comprising:
a) establishing a connection between a mobile device of the user and the hospitality facility;
b) determining whether a user application is installed on the mobile device;
c) downloading and installing the user application on the mobile device, if not already present;
d) connecting the user's personal electronic device to a web server, wherein the web server contains information relating to the hospitality facility and its amenities and connecting the user's personal electronic device to a communication module, wherein the communication module connects the user application to a PBX system located at the hospitality facility;
e) transmitting data between the user application and the web server;
f) displaying information relating to the hospitality facility on a display of the mobile device.

11. The method of claim 10, wherein the connection in step (a) is established by the user scanning a QR code with the mobile device.

12. The method of claim 10, wherein the connection in step (a) is established by the user manually connecting the mobile device to a wireless network of the facility.

13. The method of claim 10 further including the step of:
g) communicating telephonically between the user of the mobile device and an amenity of the facility over the facility's PBX system through the user application.

14. The method of claim 13, wherein identifying information of the user is provided to the PBX system when the user connects to a facility amenity.

15. The method of claim 14, wherein the identifying information is a room number assigned to the user.

16. The method of claim 13, wherein location information is displayed on the user's mobile device when an incoming phone call is placed by the facility.
